(19) United States
(12) Patent Application Publication
(10) Pub. No.: US 2021/0363344 A1
(43) Pub. Date: Nov. 25, 2021

(54) POLYLACTIC ACID COMPOSITE AND USE THEREOF

(71) Applicant: Kingfa Csi, & Tech. Co. Ltd., Guangzhou (CN)

(72) Inventors: Changli LU, Guangzhou (CN); Zhimin YUAN, Guangzhou (CN); Tongmin CAI, Guangzhou (CN); Xianbo HUANG, Guangzhou (CN); Xiangbin ZENG, Guangzhou (CN); Jian JIAO, Guangzhou (CN); Kai XIONG, Guangzhou (CN); Hui YANG, Guangzhou (CN); Kaijin MAI, Guangzhou (CN); Xueteng DONG, Guangzhou (CN)

(73) Assignee: Kingfa Csi, & Tech. Co. Ltd., Guangzhou (CN)

(21) Appl. No.: 16/647,507

(22) PCT Filed: Jun. 26, 2018
(86) PCT No.: PCT/CN2018/092804

§ 371 Date: Mar. 15, 2020

(30) Foreign Application Priority Data
Oct. 27, 2017 (CN) 201711019796.5

(51) Int. Cl. C08L 67/04; C08K 5/00; C08L 71/02; B29C 45/00; B29C 48/00; C08K 3/013

(52) U.S. Cl. CPC C08L 67/04; C08K 5/0016; C08L 71/02; B29C 45/0001; B29C 48/022; B29L 2031/529; C08L 2201/06; C08L 2203/30; C08L 2205/02; C08L 2205/03; C08K 3/013

(57) ABSTRACT

The present invention discloses a polylactic acid composite and use thereof. The polylactic acid composite includes the following components: i) 50-85 parts by weight of polylactic acid; ii) 8 to 35 parts by weight of an inorganic filler; and iii) 0 to 8 parts by weight of a plasticizer; wherein the polylactic acid composite has an end carboxyl content of 12 to 51 molKOH/t. The present invention unexpectedly discovered through research that, by controlling an end carboxyl content of the polylactic acid composite within a range of 12 to 51 molKOH/t, the polylactic acid composite, under a condition of 60° C. and 60% humidity, with a test time of 30 days, has a ratio of a mass melt index MFIₜ₌₃₀ to an initial mass melt index MFIₜ₌₀ satisfying 3.5<η=MFIₜ₌₃₀/MFIₜ₌₀<5.1, which indicates that under the test conditions, the product has slow aging degradation, and the polylactic acid composite has a biodegradation rate greater than 90% after 12 weeks in the case where a thickness is 2.5 mm or less, and has suitable aging properties and excellent biodegradability.

### TECHNICAL FIELD

The present invention belongs to the technical field of polymer material modification, and in particular, relates to a polylactic acid composite and use thereof.

### BACKGROUND

Polylactic resin is a polymer material obtained by chemical synthesis or biosynthesis using lactic acid as a monomer. Its raw materials are mainly corn, potato, etc., so its price is low. At the same time, as its raw materials are natural crops, carbon emissions are very low. From a safety point of view, polylactic acid is non-toxic and non-irritating, has excellent transparency and biodegradability, and is easily catabolized by a variety of microorganisms in nature or enzymes in plants and animals, eventually forming carbon dioxide and water, and thereby to a certain extent, it reduces white pollution and is an ideal green polymer material.

In addition to being biodegradable, products made of polylactic acid have good biocompatibility, glossiness, and transparency, and also have certain bacterial resistance and UV resistance, and therefore it is widely used in medical, spinning, tableware, toys and other fields.

At present, polylactic acid products are mostly disposable products or fast-moving consumer goods that do not have strict requirements on the service life. Because of the effects of microorganisms, light, radiation, air, and the physical environment in contact, polylactic acid products are easily aged and degraded during processing, storage and transportation, which affects the use of the final product.

Starting from the above problems, it was surprisingly found that according to the present invention, by controlling an acid end group content of the polylactic acid composite within a certain range, the composite can have suitable aging properties and excellent biodegradability.

### SUMMARY OF THE INVENTION

An objective of the present invention is to provide a polylactic acid composite, and the polylactic acid composite has suitable aging properties and excellent biodegradability.

The present invention is achieved by the following technical solution:

a polylactic acid composite, including the following components in parts by weight:

i) 50 to 85 parts by weight of polylactic acid;

ii) 8 to 35 parts by weight of an inorganic filler; and

iii) 0 to 8 parts by weight of a plasticizer;

wherein the polylactic acid composite has an end carboxyl content of 12 to 51 molKOH/t.

In particular, a measurement method of the end carboxyl content is as follows: using a mixed liquor of o-cresol and trichloromethane with a mass ratio of 7:3 as a solvent, measuring an end carboxyl value with a Metrohm Titrino series automatic potentiometric titrator, carrying out a measuring method using FZ/T 50012-2006 “Determination for end carboxyl content in polyester-titration analysis method”, rounding off a one decimal place after the decimal point of an end carboxyl value according to a rounding method.

There are many factors that affect the end carboxyl content of polylactic acid composite, for example, different microstructure of the raw material polylactic acid. As known to those skilled in the art, polylactic acid can be obtained by direct polycondensation of lactic acid or by ring-opening polymerization of lactide. During the synthesis process, if polylactic acid is not end-capped with an end-capping reagent, the synthesized polylactic acid is a polymer containing a certain end carboxyl content. In addition, during the synthesis of polylactic acid, by controlling the amount of catalyst added and adjusting the degree of vacuum and the reaction time, it will also affect the end carboxyl content of the synthesized polylactic acid, thereby making the microstructure of polylactic acid different. Due to the high temperature melting during the modification of the polylactic acid composite, high temperature melting itself is the balance for further reaction and degradation of polymer end groups, and with the addition of various additives, etc., it will have a certain impact on the end carboxyl content of the finally prepared polylactic acid composite, so that the product will show different aging properties and biodegradability in the macro.

The present invention found through research that controlling the end carboxyl content of the polylactic acid composite within a range of 12 to 51 molKOH/t can make the composite have suitable aging properties and excellent biodegradability. The higher the end carboxyl content of the polylactic acid composite, the more likely it is to degrade after being discarded, which is good for reducing environmental pollution. However, the excessive end carboxyl content in the polylactic acid composite may cause aging degradation of polylactic acid products during processing, storage, and transportation, which affects the use of final products. If the end carboxyl content of polylactic acid composite is too low, it means that more catalysts, lower vacuum, longer reaction time are required during the synthesis process, while more sophisticated equipment and more capital investment are required, and it will also generate higher energy consumption. Therefore, preferably, an end carboxyl content of the polylactic acid composite is 18 to 41 molKOH/t; preferably 28 to 36 molKOH/t.

The polylactic acid composite, under a condition of 60° C. and 60% humidity, with a test time of 30 days, has a ratio of a mass melt index MFIₜ₌₃₀ to an initial mass melt index MFIₜ₌₀ satisfies the following relationship:

3.5<η=MFIₜ₌₃₀/MFIₜ₌₀<5.1;

preferably, 3.9<η=MFIₜ₌₃₀/MFIₜ₌₀<4.7;

more preferably, 4.2<η=MFIₜ₌₃₀/MFIₜ₌₀<4.5;

a mass melt index MFI of the polylactic acid composite is tested according to standard ASTM D1238, and test conditions are 190° C., 2.16 kg, with a unit of g/10 min.

According to ISO 16929 (2013), the polylactic acid composite has a biodegradation rate greater than 90% after 12 weeks in a case where a thickness is 2.5 mm or less.

The inorganic filler is selected from one or a mixture of more of talcum powder, montmorillonite, kaolin, chalk, calcium carbonate, gypsum, calcium chloride, iron oxide, dolomite, silicon dioxide, wollastonite, titanium dioxide, silicate, and mica, preferably one or a mixture of more of talcum powder, calcium carbonate, and silicon dioxide. The addition of the inorganic filler can not only improve the mechanical properties of the material, but the inorganic filler can also act as a nucleating agent, increase a crystallization rate of a polyester composition, and improve processing conditions of the polylactic acid composite.

The plasticizer which is liquid at room temperature is selected from one or a mixture of more of glycerol, polyglycerol, ethylene glycol, polyethylene glycol-400, polyethylene glycol-600, polyethylene glycol-800, epoxy soybean oil, citrate, acetyl citrate, triacetyl glyceride, and dioctyl adipate.

Plasticizers that are liquid at room temperature are mostly low-molecular-weight compounds. The addition of a low-molecular-weight plasticizer to polylactic acid can help promote the movement of polylactic acid segments, thereby improving tenacity of the polylactic acid composite to a certain extent. At the same time, the low-molecular-weight plasticizer can more effectively promote the crystallization of the polylactic acid and increase the heat-resistant temperature of the polylactic acid to a certain extent.

The polylactic acid composite further includes 0 to 10 parts by weight of a flexibilizer, and the flexibilizer is preferably an aliphatic polyester or an aliphatic-aromatic copolyester.

According to the actual performance requirements, the polylactic acid composite according to the present invention, in parts by weight, further includes 0 to 4 parts by weight of the following other additive: a release agent, a surfactant, a wax, an antistatic agent, a dye, or other plastic additive.

The release agent is silicone masterbatch, montan wax, erucylamide, or oleamide.

The surfactant is one or a mixture of more of polysorbate, palmitate, and laurate.

The wax is one or a mixture of more of erucylamide, stearamide, behenamide, beeswax, and beeswax ester.

The antistatic agent is a permanent antistatic agent, and specific examples include one or a mixture of more of PELESTAT-230, PELESTAT-6500, and SUNNICO ASA-2500.

The dye is one or a mixture of more of carbon black, black color base, titanium dioxide, zinc sulfide, phthalocyanine blue, and fluorescent orange.

Said other plastic additive may be nucleating agent, antifogging agent, lubricant (such as calcium stearate), primary antioxidant, auxiliary antioxidant, etc.

The present invention further provides use of the above-described polylactic acid composite in injection-grade, blister-grade, and extrusion-grade products such as tableware, toys, and stationery.

Compared with the prior art, the present invention has the following beneficial effects:

The present invention unexpectedly discovered through research that, by controlling an end carboxyl content of the polylactic acid composite within a range of 12 to 51 molKOH/t, the polylactic acid composite, under a condition of 60° C. and 60% humidity, with a test time of 30 days, has a ratio of a mass melt index MFIₜ₌₃₀ to an initial mass melt index MFIₜ₌₀ satisfying 3.5<η=MFIₜ₌₃₀/MFIₜ₌₀<5.1, which indicates that under the test conditions, the product has slow aging degradation, and the polylactic acid composite has a biodegradation rate greater than 90% after 12 weeks in the case where a thickness is 2.5 mm or less, and has suitable aging properties and excellent biodegradability.

### DETAILED DESCRIPTION OF THE PREFERRED EMBODIMENT

The present invention is further described below by specific implementations, and the following embodiments are preferable implementations of the present invention, but the implementation of the present invention is not limited by the following embodiments.

The raw materials used in the present invention are all commercially available.

Performance Test Method:

biodegradation rate: according to ISO 16929 (2013), a thickness was 2.5 mm or less, and the biodegradation rate of the polylactic acid composite after 12 weeks was tested.

η: under a condition of 60° C. and 60% humidity, with a test time of 30 days, a ratio of a mass melt index MFIₜ₌₃₀ to an initial mass melt index MFIₜ₌₀, η=MFIₜ₌₃₀/MFIₜ₌₀, the lower the η value, the slower the aging degradation of the product, the better the aging resistance.

Mass melt index MFI: was tested according to standard ASTM D1238, and test conditions were 190° C., 2.16 kg, with a unit of g/10 min.

A measurement method of the end carboxyl content was as follows: a mixed liquor of o-cresol and trichloromethane with a mass ratio of 7:3 was used as a solvent, an end carboxyl value was measured with a Metrohm Titrino series automatic potentiometric titrator, a measuring method was carried out using FZ/T 50012-2006 “Determination for end carboxyl content in polyester-titration analysis method”, a one decimal place after the decimal point of an end carboxyl value was rounded off according to a rounding method.

### Synthesis of Polylactic Acid

### Embodiment A1

20 mol of commercially available L-lactide was taken as a raw material, toluene was used as an organic solution, 0.035 mol of stannous octoate was added as a catalyst, and they were added into a 20 L stainless steel reactor, the reactor was depressurized to high vacuum of 0.080 MPa, and slowly heated to 145° C. Stirring was conducted for 1 hour to completely dissolve lactide. The toluene steam generated by heating was extracted, the vacuum was maintained at 0.080 MPa, and the reaction was stopped after the reaction was carried out at a constant temperature of 145° C. for 18 hours. After the pressure in the reactor became normal pressure, ethyl acetate was added to dissolve the solid in the reactor, and then was pour into a container for air dry. After the ethyl acetate solvent was completely evaporated, it was placed in a vacuum dryer for use.

Acid end group value: 14 mgKOH/g.

Unit power consumption: 85 kw·h/Kg.

### Embodiment A2

20 mol of commercially available L-lactide was taken as a raw material, toluene was used as an organic solution, 0.035 mol of stannous octoate was added as a catalyst, and they were added into a 20 L stainless steel reactor, the reactor was depressurized to high vacuum of 0.080 MPa, and slowly heated to 145° C. Stirring was conducted for 1 hour to completely dissolve lactide. The toluene steam generated by heating was extracted, the vacuum was maintained at 0.080 MPa, and the reaction was stopped after the reaction was carried out at a constant temperature of 145° C. for 13 hours. After the pressure in the reactor became normal pressure, ethyl acetate was added to dissolve the solid in the reactor, and then was pour into a container for air dry. After the ethyl acetate solvent was completely evaporated, it was placed in a vacuum dryer for use.

Acid end group value: 19 mgKOH/g.

Unit power consumption: 63 kw·h/Kg.

### Embodiment A3

20 mol of commercially available L-lactide was taken as a raw material, toluene was used as an organic solution, 0.027 mol of stannous octoate was added as a catalyst, and they were added into a 20 L stainless steel reactor, the reactor was depressurized to high vacuum of 0.101 MPa, and slowly heated to 135° C. Stirring was conducted for 1 hour to completely dissolve lactide. The toluene steam generated by heating was extracted, the vacuum was maintained at 0.101 MPa, and the reaction was stopped after the reaction was carried out at a constant temperature of 135° C. for 12 hours. After the pressure in the reactor became normal pressure, ethyl acetate was added to dissolve the solid in the reactor, and then was pour into a container for air dry. After the ethyl acetate solvent was completely evaporated, it was placed in a vacuum dryer for use.

Acid end group value: 25 mgKOH/g.

Unit power consumption: 60 kw·h/Kg.

### Embodiment A4

20 mol of commercially available L-lactide was taken as a raw material, toluene was used as an organic solution, 0.027 mol of stannous octoate was added as a catalyst, and they were added into a 20 L stainless steel reactor, the reactor was depressurized to high vacuum of 0.101 MPa, and slowly heated to 135° C. Stirring was conducted for 1 hour to completely dissolve lactide. The toluene steam generated by heating was extracted, the vacuum was maintained at 0.101 MPa, and the reaction was stopped after the reaction was carried out at a constant temperature of 135° C. for 9 hours. After the pressure in the reactor became normal pressure, ethyl acetate was added to dissolve the solid in the reactor, and then was pour into a container for air dry. After the ethyl acetate solvent was completely evaporated, it was placed in a vacuum dryer for use.

Acid end group value: 31 mgKOH/g.

Unit power consumption: 52 kw·h/Kg.

### Embodiment A5

20 mol of commercially available L-lactide was taken as a raw material, toluene was used as an organic solution, 0.022 mol of stannous octoate was added as a catalyst, and they were added into a 20 L stainless steel reactor, the reactor was depressurized to high vacuum of 0.150 MPa, and slowly heated to 130° C. Stirring was conducted for 1 hour to completely dissolve lactide. The toluene steam generated by heating was extracted, the vacuum was maintained at 0.150 MPa, and the reaction was stopped after the reaction was carried out at a constant temperature of 130° C. for 9 hours. After the pressure in the reactor became normal pressure, ethyl acetate was added to dissolve the solid in the reactor, and then was pour into a container for air dry. After the ethyl acetate solvent was completely evaporated, it was placed in a vacuum dryer for use.

Acid end group value: 36 mgKOH/g.

Unit power consumption: 50 kw·h/Kg.

### Comparative Example B1

20 mol of commercially available L-lactide was taken as a raw material, toluene was used as an organic solution, 0.022 mol of stannous octoate was added as a catalyst, and they were added into a 20 L stainless steel reactor, the reactor was depressurized to high vacuum of 0.150 MPa, and slowly heated to 130° C. Stirring was conducted for 1 hour to completely dissolve lactide. The toluene steam generated by heating was extracted, the vacuum was maintained at 0.150 MPa, and the reaction was stopped after the reaction was carried out at a constant temperature of 130° C. for 6 hours. After the pressure in the reactor became normal pressure, ethyl acetate was added to dissolve the solid in the reactor, and then was pour into a container for air dry. After the ethyl acetate solvent was completely evaporated, it was placed in a vacuum dryer for use.

Acid end group value: 48 mgKOH/g.

Unit power consumption: 36 kw·h/Kg.

### Comparative Example B2

20 mol of commercially available L-lactide was taken as a raw material, toluene was used as an organic solution, 0.035 mol of stannous octoate was added as a catalyst, and they were added into a 20 L stainless steel reactor, the reactor was depressurized to high vacuum of 0.065 MPa, and slowly heated to 145° C. Stirring was conducted for 1 hour to completely dissolve lactide. The toluene steam generated by heating was extracted, the vacuum was maintained at 0.065 MPa, and the reaction was stopped after the reaction was carried out at a constant temperature of 145° C. for 21 hours. After the pressure in the reactor became normal pressure, ethyl acetate was added to dissolve the solid in the reactor, and then was pour into a container for air dry. After the ethyl acetate solvent was completely evaporated, it was placed in a vacuum dryer for use.

Acid end group value: 9 mgKOH/g.

Unit power consumption: 92 kw·h/Kg.

After polylactic acid, organic filler, plasticizer and calcium stearate were mixed evenly according to the formulas in Table 1, the mixture was put into a twin-screw extruder to extrude and pellet at 150° C. to 220° C. to obtain a polylactic acid composite. The performance test data is shown in Table 1.

TABLE 1
Performance test results of Embodiments 1-10 and Comparative examples 1-2 (parts by weight)

| | Compa. | Compa. | Embodi- | Embodi- | Embodi- | Embodi- | Embodi- | Embodi | Embodi | Embodi- | Embodi- | Embodi- |
|---|---|---|---|---|---|---|---|---|---|---|---|---|
| | ex. 1 | ex. 2 | ment 1 | ment 2 | ment 3 | ment 4 | ment 5 | ment 6 | ment 7 | ment 8 | ment 9 | ment 10 |
| A1 | | | | | | 65 | | | | | | |
| A2 | | | | 65 | | | | | | | | |
| A3 | | | 65 | | | | | 70 | 69 | 66 | 85 | |
| A4 | | | | | 65 | | | | | | | |
| A5 | | | | | | | 65 | | | | | 55 |
| B1 | | 65 | | | | | | | | | | |
| B2 | 65 | | | | | | | | | | | |
| talcum | 28 | 28 | 28 | 28 | 28 | 28 | 28 | 28 | 28 | 20 | 9 | 35 |
| powder | | | | | | | | | | | | |
| PEG 400 | 5 | 5 | 5 | 5 | 5 | 5 | 5 | | 1 | 2 | 4 | 8 |
| calcium | 2 | 2 | 2 | 2 | 2 | 2 | 2 | 2 | 2 | 2 | 2 | 2 |
| stearate | | | | | | | | | | | | |
| acid end | 10 | 55 | 30 | 25 | 40 | 17 | 48 | 37 | 30 | 33 | 43 | 45 |
| group | | | | | | | | | | | | |
| content of | | | | | | | | | | | | |
| polylactic | | | | | | | | | | | | |
| acid | | | | | | | | | | | | |
| composite | | | | | | | | | | | | |
| mol/kg | | | | | | | | | | | | |
| η | 3.1 | 5.8 | 4.2 | 3.9 | 4.6 | 3.5 | 5.0 | 4.6 | 4.4 | 4.5 | 4.8 | 5.1 |
| biode- | 87.8 | 97.5 | 92.3 | 91.8 | 94.2 | 90.2 | 96.8 | 94.0 | 94.1 | 94.5 | 95.3 | 97.8 |
| gradation | | | | | | | | | | | | |
| rate % | | | | | | | | | | | | |

It can be seen from the results in Table 1 that, in the embodiments of the present invention, by controlling the end carboxyl content of the polylactic acid composite within a range of 12 to 51 molKOH/t, the melt index of the composite can be brought into a reasonable range under test conditions, and in the case where a thickness is 2.5 mm or less, the polylactic acid composite has a biodegradation rate greater than 90% after 12 weeks, and has suitable aging properties and excellent biodegradability. In comparative example 1, the end carboxyl content of the polylactic acid composite is lower than 12 molKOH/t, and the biodegradation rate of the composite is lower than 90%. In comparative example 2, the end carboxyl content of the polylactic acid composite is higher than 51 mol/kg, although the composite has a higher biodegradation rate, its melt index rises faster during the test cycle and has poor aging resistance.

1. A polylactic acid composite, characterized in that, comprises the following components in parts by weight:
i) 50 to 85 parts by weight of polylactic acid;
ii) 8 to 35 parts by weight of an inorganic filler; and
iii) 0 to 8 parts by weight of a plasticizer;
wherein the polylactic acid composite has an end carboxyl content of 12 to 51 molKOH/t.

2. The polylactic acid composite according to claim 1, wherein a measurement method of the end carboxyl content is as follows: using a mixed liquor of o-cresol and trichloromethane with a mass ratio of 7:3 as a solvent, measuring an end carboxyl value with a Metrohm Titrino series automatic potentiometric titrator, carrying out a measuring method using FZ/T 50012-2006 “Determination for end carboxyl content in polyester-titration analysis method”, rounding off a one decimal place after the decimal point of an end carboxyl value according to a rounding method.

3. The polylactic acid composite according to claim 1, wherein the end carboxyl content of the polylactic acid composite is 18 to 41 molKOH/t, preferably 28 to 36 molKOH/t.

4. The polylactic acid composite according to claim 1, wherein under a condition of 60° C. and 60% humidity, with a test time of 30 days, a ratio of a mass melt index MFIₜ₌₃₀ of the polylactic acid composite to an initial mass melt index MFIₜ₌₀ satisfies the following relationship:
3.5<η=MFIₜ₌₃₀/MFIₜ₌₀<5.1;
preferably, 3.9<η=MFIₜ₌₃₀/MFIₜ₌₀<4.7;
more preferably, 4.2<η=MFIₜ₌₃₀/MFIₜ₌₀<4.5;
a mass melt index MFI of the polylactic acid composite is tested according to standard ASTM D1238, and test conditions are 190° C., 2.16 kg, with a unit of g/10 min.

5. The polylactic acid composite according to claim 1, wherein according to ISO 16929 (2013), the polylactic acid composite has a biodegradation rate greater than 90% after 12 weeks when a thickness is 2.5 mm or less.

6. The polylactic acid composite according to claim 1, wherein the inorganic filler is selected from one or a mixture of more of talcum powder, montmorillonite, kaolin, chalk, calcium carbonate, gypsum, calcium chloride, iron oxide, dolomite, silicon dioxide, wollastonite, titanium dioxide, silicate, and mica, preferably one or a mixture of more of talcum powder, calcium carbonate, and silicon dioxide.

7. The polylactic acid composite according to claim 1, wherein the plasticizer which is liquid at room temperature is selected from one or a mixture of more of glycerol, polyglycerol, ethylene glycol, polyethylene glycol-400, polyethylene glycol-600, polyethylene glycol-800, epoxy soybean oil, citrate, acetyl citrate, triacetyl glyceride, and dioctyl adipate.

8. The polylactic acid composite according to claim 1, wherein in parts by weight, the polylactic acid composite further comprises 0 to 10 parts by weight of a flexibilizer, and the flexibilizer is an aliphatic polyester or an aliphatic-aromatic copolyester.

9. The polylactic acid composite according to claim 1, wherein in parts by weight, the polylactic acid composite further comprises 0 to 4 parts by weight of the following other additive: a release agent, a surfactant, a wax, an antistatic agent, a dye, or other plastic additive.

10. An injection-grade, blister-grade, or extrusion-grade product comprising the polylactic acid composite according to claim 1, wherein the injection-grade, blister-grade, or extrusion-grade product includes tableware, toys, and stationery.

11. An injection-grade, blister-grade, or extrusion-grade product comprising the polylactic acid composite according to claim 2, wherein the injection-grade, blister-grade, or extrusion-grade product includes tableware, toys, and stationery.

12. An injection-grade, blister-grade, or extrusion-grade product comprising the polylactic acid composite according to claim 3, wherein the injection-grade, blister-grade, or extrusion-grade product includes tableware, toys, and stationery.

13. An injection-grade, blister-grade, or extrusion-grade product comprising the polylactic acid composite according to claim 4, wherein the injection-grade, blister-grade, or extrusion-grade product includes tableware, toys, and stationery.

14. An injection-grade, blister-grade, or extrusion-grade product comprising the polylactic acid composite according to claim 5, wherein the injection-grade, blister-grade, or extrusion-grade product includes tableware, toys, and stationery.

15. An injection-grade, blister-grade, or extrusion-grade product comprising the polylactic acid composite according to claim 6, wherein the injection-grade, blister-grade, or extrusion-grade product includes tableware, toys, and stationery.

16. An injection-grade, blister-grade, or extrusion-grade product comprising the polylactic acid composite according to claim 7, wherein the injection-grade, blister-grade, or extrusion-grade product includes tableware, toys, and stationery.

17. An injection-grade, blister-grade, or extrusion-grade product comprising the polylactic acid composite according to claim 8, wherein the injection-grade, blister-grade, or extrusion-grade product includes tableware, toys, and stationery.

18. An injection-grade, blister-grade, or extrusion-grade product comprising the polylactic acid composite according to claim 9, wherein the injection-grade, blister-grade, or extrusion-grade product includes tableware, toys, and stationery.
